(19) United States
(12) Patent Application Publication
(10) Pub. No.: US 2024/0406102 A1
(43) Pub. Date: Dec. 5, 2024

(54) EFFICIENT TRAFFIC MANAGEMENT IN OVERLAY NETWORK BASED ON HIERARCHICAL IDENTIFIERS

(71) Applicant: Hewlett Packard Enterprise Development LP, Spring, TX (US)

(72) Inventors: Saumya Dikshit, Bangalore (IN); Thomas Samuel, Bangalore (IN)

(21) Appl. No.: 18/204,196

(22) Filed: May 31, 2023

(51) Int. Cl. H04L 45/64; H04L 45/02; H04L 45/16

(52) U.S. Cl. CPC H04L 45/64; H04L 45/04; H04L 45/16

(57) ABSTRACT

A system for efficient traffic management is provided. During operation, the system can receive a first route update via a first tunnel coupling a first switch in a first overlay tunnel fabric of a network site. The first route update can include a first set of hierarchical identifiers associated with the first switch. Here, a respective identifier can correspond to a distinct networking hierarchy with respect to the first switch. The system can also receive a second route update via a second tunnel coupling a second switch in a second overlay tunnel fabric of the site. The second route update can include a second set of hierarchical identifiers associated with the second switch. Upon receiving a packet via a tunnel, the system can determine whether to forward the packet to the first switch and the second switch based on the first and second sets of hierarchical identifiers, respectively.

### BACKGROUND

### Field

The present disclosure relates to communication networks. More specifically, the present disclosure relates to a method and system for using hierarchical identifiers to efficiently manage traffic forwarding in a multi-fabric overlay network.

### BRIEF DESCRIPTION OF THE FIGURES

FIG. 1A illustrates an example of hierarchical identifiers in a multi-fabric overlay network, in accordance with an aspect of the present application.

FIG. 1B illustrates an example of multi-depth hierarchical identifiers in a multi-fabric overlay network, in accordance with an aspect of the present application.

FIG. 1C illustrates an example of broadcast-domain-level hierarchical identifiers in a multi-fabric overlay network, in accordance with an aspect of the present application.

FIG. 2 illustrates an example of an overlay route packet for notifying hierarchical identifiers in an overlay network, in accordance with an aspect of the present application.

FIG. 3 illustrates an example of efficient traffic management in a multi-fabric overlay network based on hierarchical identifiers, in accordance with an aspect of the present application.

FIG. 4A presents a flowchart illustrating an example of a process of a switch distributing hierarchical identifiers in an overlay network, in accordance with an aspect of the present application.

FIG. 4B presents a flowchart illustrating an example of a process of a border switch distributing hierarchical identifiers in an overlay network, in accordance with an aspect of the present application.

FIG. 4C presents a flowchart illustrating an example of a process of a switch processing hierarchical identifiers in an overlay network, in accordance with an aspect of the present application.

FIG. 5 presents a flowchart illustrating an example of a process of a switch forwarding traffic in an overlay network based on hierarchical identifiers, in accordance with an aspect of the present application.

FIG. 6 illustrates an example of a switch supporting efficient traffic management based on hierarchical identifiers, in accordance with an aspect of the present application.

In the figures, like reference numerals refer to the same figure elements.

### DETAILED DESCRIPTION

A heterogeneous multi-layer network, such as an overlay network, can be formed based on tunneling and virtual private networks (VPNs). A switch can then encapsulate a respective packet received from a client device with a tunnel header and forward it to another switch via a tunnel. The tunnels can be formed based on the overlay routing for a VPN over the tunnels, such as an Ethernet VPN (EVPN), that can be deployed as an overlay over a set of virtual extensible local area networks (VXLANs). The switches in the overlay network can use overlay route packets (e.g., EVPN type 2 and 3 route updates) to notify each other regarding route updates. To deploy a VPN over the tunnels, a respective tunnel endpoint may map a respective client virtual local area network (VLAN) to a corresponding tunnel network identifier (TNI), which can identify a virtual network for a tunnel.

The TNI may appear in the tunnel header that encapsulates the packet and can be used for forwarding the encapsulated packet via the tunnel. For example, if the tunnel is formed based on VXLAN, the TNI can be a virtual network identifier (VNI) of a VXLAN header, and a tunnel endpoint can be a VXLAN tunnel endpoint (VTEP). A TNI can also be mapped to the virtual routing and forwarding (VRF) associated with the tunnels if layer-3 routing and forwarding are needed. Since a VPN can be distributed across the tunnel fabric, a VPN over the tunnel fabric can also be referred to as a distributed tunnel fabric. Since the fabric is an overlay network, a respective switch in the fabric can be a tunnel endpoint of one or more tunnels. Furthermore, a gateway switch of the fabric can be a virtual gateway switch (VGS) shared among a plurality of participating switches.

Typically, forwarding decisions in a fabric is dependent on a set of forwarding rules. For example, the split horizon rule prevents a switch from forwarding a multi-destination packet (e.g., a broadcast, unknown unicast, or multicast packet) back to a fabric that sent the packet. Similarly, the broadcast domain rule can determine whether a switch is a candidate for the multi-destination packet. These rules require a switch to identify association information associated with a remote switch. Such association information can indicate whether the remote switch is associated with a fabric, a mesh, a site, a customer, etc. However, because of the heterogeneous deployments in a multi-fabric overlay network, it can be challenging to determine the association information and enforce the forwarding rules.

The aspects described herein address the problem of efficiently managing traffic forwarding in a multi-fabric overlay network by (i) determining a set of identifiers indicating different hierarchies (e.g., fabric, mesh, site, etc.) associated with a switch; (ii) including the hierarchical identifiers in the overlay route packets for notifying other switches; and (iii) using the hierarchical identifiers in conjunction with the forwarding rules to determine whether to forward a packet. Upon identifying the hierarchical identifiers in a route packet, a respective receiving switch of the overlay network may associate the hierarchical identifiers with the sending switch. This allows a respective switch of the overlay network to determine association information based on the hierarchical identifiers and manage traffic forwarding based on the forwarding rules.

A distributed tunnel fabric in an overlay network can be coupled to other networks via the gateway switch, which can include a VGS, of the fabric. Typically, at least two switches can operate as a single switch in conjunction with each other to facilitate the VGS. Switches participating in the VGS can be referred to as participating switches. A respective participating switch can consider the other participating switches as peer participating switches (or peer switches). A respective pair of participating switches can be coupled to each other via an inter-switch link (ISL). The VGS can be associated with one or more virtual addresses (e.g., a virtual Internet Protocol (IP) address and/or a virtual media access control (MAC) address). A respective tunnel formed at the VGS can use the virtual address to form the tunnel endpoint. As a result, other tunnel endpoints (i.e., other switches) of the fabric can consider the VGS as the other tunnel endpoint for a tunnel instead of any of the participating switches. Even though a switch in a distributed tunnel fabric may not be a

To forward traffic toward the VGS, a respective switch in the fabric can perform a load balancing operation (e.g., based on hashing on a respective packet) and select one of the participating switches as the destination (i.e., as the other tunnel endpoint). The switch can then forward the packet via a tunnel between the tunnel endpoints. Hence, an endpoint may forward a multicast control packet to one of the participating switches, which in turn, can share the control packet with a peer participating switch via the ISL. If the fabric is a multi-fabric network, the fabric can be one of a plurality of fabrics forming the network. A respective fabric can then include a gateway switch, which can include a VGS, that can be coupled to a remote gateway switch of another fabric, an external network, or both.

For example, the gateway switch can be coupled to the remote gateway switch via an inter-fabric tunnel (i.e., a tunnel coupling two fabrics). A packet received at the gateway switch via an intra-fabric tunnel (i.e., a tunnel within a fabric) can be encapsulated with a tunnel header associated with the intra-fabric tunnel. The gateway switch can decapsulate the tunnel header and re-encapsulate the packet with another tunnel header associated with the inter-fabric tunnel. A respective switch operating as a tunnel endpoint in the fabric can use a routing protocol, such as Border Gateway Protocol (BGP). In a multi-fabric overlay network, routes for intra-fabric tunnels can be determined by using internal BGP (iBGP) while the routes for inter-fabric tunnels can be determined by using external BGP (eBGP).

A multi-fabric overlay network may be distributed across multiple sites. For example, if the network is for an enterprise, the sites can correspond to different office sites distributed across the globe. However, if a site is large, or sites are adjacent to each other, there can be multiple fabrics deployed close to each other. These fabrics are often coupled to each other and the external network (e.g., a wide-area network or WAN) via a shared switch, which can be a border core switch in the WAN. Since the border switch can be shared among a plurality of fabrics, these fabrics can also be referred to as sharing fabrics. The same border switch can support external communication for the sharing fabrics. A multicast source can be coupled to one of the sharing fabrics (e.g., a source fabric) while a requesting host can be coupled to another one (e.g., a requesting fabric). If the host sends a join request, the switch coupling the host (e.g., a requesting switch) in the requesting fabric can receive the join request and forward it to the border switch.

With existing technologies, the border switch may forward the join request back to the requesting fabric while forwarding the request to the switch coupling the source (e.g., a source switch) via the source fabric. Consequently, the multicast traffic distribution may not converge in the requesting fabric. On the other hand, the host and the source can be coupled to the same fabric in the sharing fabrics. If the border switch is configured as the Rendezvous Point (RP) for a multicast group, the join request from the host and the multicast data flow (or multicast flow) from the source can both be forwarded to the border switch. Accordingly, the border switch can add the requesting switch to the outgoing interface list (OList) of the multicast group. Hence, the border switch may forward the multicast flow to the requesting switch. However, the multicast flow can also be directly forwarded to the requesting switch from the source switch via a corresponding tunnel in the fabric. As a result, the requesting switch may receive multiple multicast flows.

Because the border switch can be coupled to multiple fabrics, the border switch needs to enforce split horizon rules for inter-fabric traffic. For example, a packet received from an inter-fabric tunnel may not be forwarded to another inter-fabric tunnel of the same fabric. Hence, the border switch needs to distinguish between fabrics at the local site. Moreover, a switch may use iBGP and eBGP to determine routes for inter- and intra-fabric tunnels, respectively. However, a fabric may include a route server (RS), which can be an underlay device that does not operate as a tunnel endpoint and can relay route advertisements. The RS typically operates as a route-relay entity among eBGP peers. As a result, the route advertisements relayed by the RS can be based on eBGP. Consequently, the switch may not be able to distinguish between inter- and intra-fabric tunnels using eBGP and iBGP, respectively.

To address these problems, a respective switch operating as a tunnel endpoint in an overlay network can be configured with a set of hierarchical identifiers. Each of these identifiers can correspond to a hierarchy of topology and configuration for the switch. For example, if the switch is a tunnel endpoint in a fabric at a site, the hierarchical identifies can include a fabric identifier identifying the fabric and a site identifier identifying the site. The depth of the hierarchical identifiers, which can indicate the depth or level of the hierarchy, can then be two. In other words, the depth value can indicate the number of identifiers in the hierarchical identifiers. In addition, there can be multiple mesh networks and associated broadcast domains (e.g., for different VLANs) among the switches. Under such circumstances, the hierarchical identifiers can also include a mesh identifier that can identify the mesh network associated with the switch with a depth of three.

Similarly, the hierarchical identifiers may also include other identifiers, such as a VNI, a VLAN, a role identifier (e.g., associated with role-based traffic segmentation), and a chassis number. The border switch can also be configured with a set of VNIs. Similarly, a respective switch of a respective fabric can be configured with a corresponding set of VNIs. These VNIs can be included in the hierarchical identifiers. Upon receiving the overlay route packets from multiple fabrics, the border switch can determine which VNI of the local VNIs is to be extended for which fabric based on the hierarchical identifiers. For example, if a particular VNI is advertised from two fabrics, the border switch can determine that the VNI should be extended across those two fabrics.

In this way, the hierarchical identifiers can group the switches into different hierarchies. For example, if a site includes two fabrics, the site identifier for switches in both fabrics can be the same while the fabric identifiers can be different. A respective switch can send an overlay route packet to advertise its associated hierarchical identifiers. The overlay route packet can include a set of dedicated fields to incorporate the depth value and the hierarchical identifiers. For example, the overlay route packet can be an EVPN route advertisement (e.g., a network layer reachability information (NLRI)) and the dedicated fields can be an extended community defined for the EVPN route advertisements. The community can carry a number of hierarchical identifiers indicated by the depth value.

Based on the hierarchical identifiers, a respective switch can implement a set of forwarding rules, such as split horizon rules, ISL rules, and broadcast domain rules, to determine whether a packet (e.g., a multicast packet) should be forwarded to another switch. Furthermore, if there are multiple fabrics at a site, external communication can be managed by the shared border switch. Hence, the border switch can use the site identifier and a default fabric identifier (e.g., a value of 0) in an overlay route packet to consolidate route updates from the local fabrics and advertise the consolidated route update across external links to remote sites. Accordingly, switches of other sites can then forward control and data packets to the border switch without considering individual fabrics. In this way, advertising the hierarchical identifiers via the overlay route packets can ensure efficient traffic forwarding in an overlay network.

In this disclosure, the term “switch” is used in a generic sense, and it can refer to any standalone or fabric switch operating in any network layer. “Switch” should not be interpreted as limiting examples of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

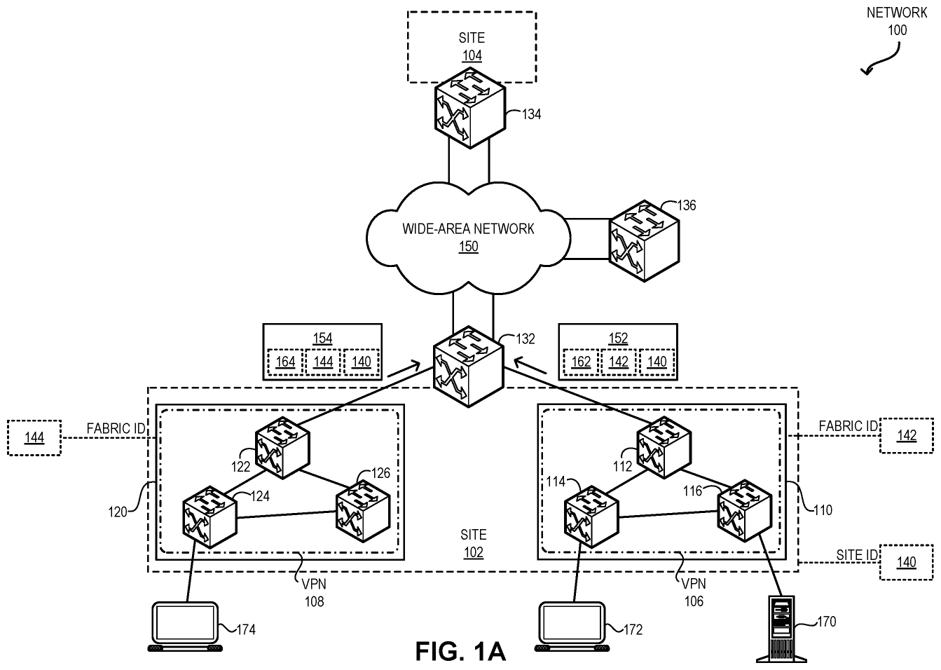

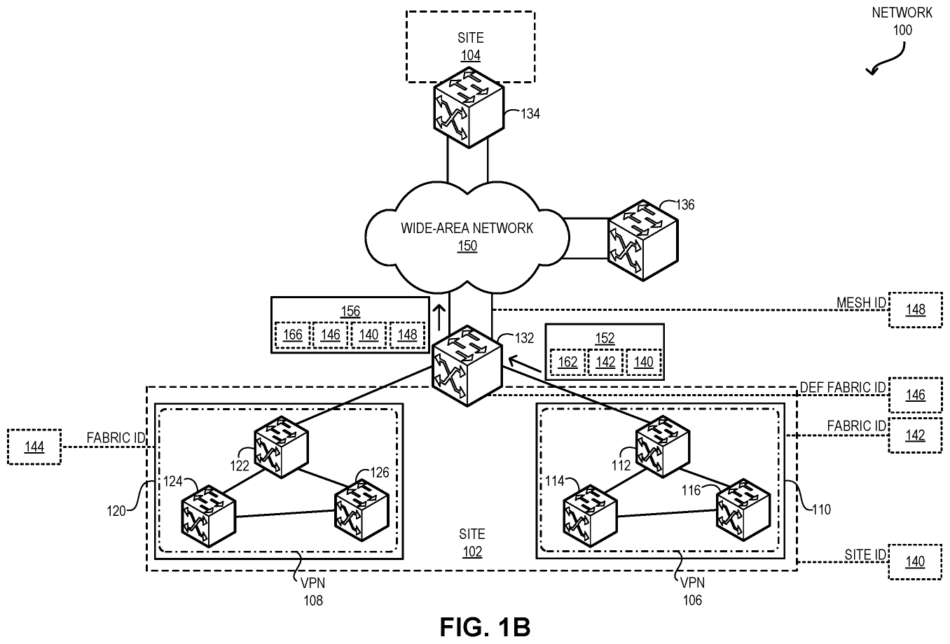

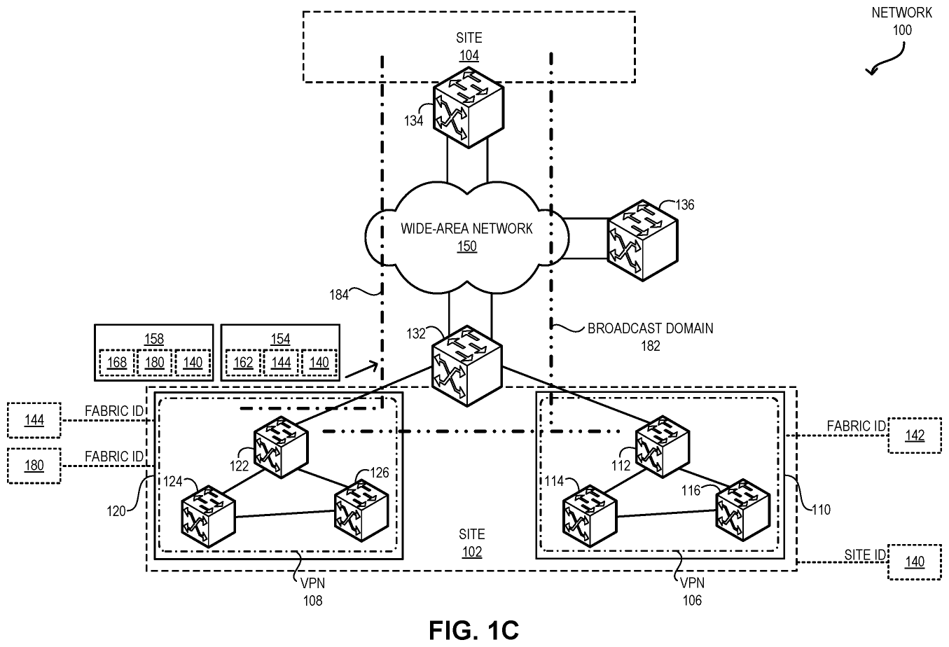

FIG. 1A illustrates an example of hierarchical identifiers in a multi-fabric overlay network, in accordance with an aspect of the present application. An overlay network 100 can include a number of switches and devices, and may include heterogeneous network components, such as layer-2 and layer-3 hops, and tunnels. In some examples, network 100 can be an Ethernet, InfiniBand, or other networks, and may use a corresponding communication protocol, such as Internet Protocol (IP), FibreChannel over Ethernet (FCOE), or other protocol. Network 100 can be distributed among multiple sites 102 and 104, which can be different sites of an enterprise network. Network 100 can include a plurality of distributed tunnel fabrics 110 and 120 at site 102. Hence, network 100 can be a multi-fabric network. Fabric 110 can include switches 112, 114, and 116; and fabric 120 can include switches 122, 124, and 128. A respective switch in a respective fabric can be associated with a MAC address and an IP address. In a respective fabric of network 100, switches can be coupled to each other via a tunnel.

In FIG. 1A, a link denoted with a solid line between a switch pair can indicate a tunnel. Switches of a respective fabric in network 100 may include one or more meshes of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), Multiprotocol Label Switching (MPLS), and Generic User Datagram Protocol (UDP) Encapsulation (GUE). The tunnels in a fabric can be formed over an underlying network (or an underlay network). The underlying network can be a physical network, and a respective link of the underlying network can be a physical link. A respective switch pair in the underlying network can be a Border Gateway Protocol (BGP) peer. A VPN 106, such as an EVPN, can be deployed over fabric 110. Similarly, a VPN 108 can be deployed over fabric 120.

Switches 112 and 122 can be gateway switches for fabrics 110 and 120, respectively. One or more of switches 112 and 122 can be VGS. Multiple switches can operate as a single switch in conjunction with each other to facilitate the VGS. The participating switches can operate as a single switch in conjunction with each other to facilitate the VGS. The VGS can be associated with one or more virtual addresses (e.g., a virtual IP address and/or a virtual MAC address). A respective tunnel formed at the VGS can use the virtual address to form the tunnel endpoint. To efficiently manage data forwarding, the participating switches can maintain an ISL between them for sharing control and/or data packets. The ISL can be a layer-2 or layer-3 connection that allows data forwarding. The ISL can also be based on a tunnel (e.g., a VXLAN tunnel).

Because the virtual address of the VGS can be associated with all participating switches, other tunnel endpoints of the corresponding fabric, can consider the VGS as the other tunnel endpoint for a tunnel instead of the participating switches. To forward traffic toward the VGS, a remote switch can operate as a tunnel endpoint while the VGS can be the other tunnel endpoint. From a respective remote switch, there can be a set of paths (e.g., equal-cost multiple paths or ECMP) to the VGS. Hence, a respective path in the underlying network can lead to one of the participating switches of the VGS.

A border switch 132 can be shared among fabrics 110 and 120. Hence, switch 132 can facilitate external communication from site 102 via network 150 (e.g., a WAN, which can be the Internet). Network 100 can also include switches 134 and 136 that can facilitate communication with switch 132 via network 150. For example, switches 132 and 134 can facilitate communication between sites 102 and 104 via network 150. In network 100, switch 132 can be coupled to switches 134 and 136 via respective inter-fabric tunnels through network 150. However, switch 132 is a shared border switch, switch 132 can also be coupled to fabrics 110 and 120 (e.g., via switches 112 and 122, respectively) via respective inter-fabric tunnels.

A packet between fabrics 110 and 120 can be received at switch 112 via an intra-fabric tunnel within fabric 110 and can be encapsulated with a tunnel header associated with the intra-fabric tunnel. Switch 112 can decapsulate the tunnel header and re-encapsulate the packet with another tunnel header associated with the inter-fabric tunnel. Upon receiving the packet, switch 112 can decapsulate the tunnel header and re-encapsulate the packet with another tunnel header associated with the intra-fabric tunnel to send the packet to switch 132. Switch 112 can then decapsulate the tunnel header and re-encapsulate the packet with another tunnel header associated with the intra-fabric tunnel to fabric 120. To facilitate the forwarding of the packet, routes for intra-fabric tunnels can be determined using iBGP, and routes for inter-fabric tunnels be determined using eBGP.

A multicast source can be coupled to fabric 120 while a requesting host can be coupled to fabric 110. If the host sends a join request, the join request can be forwarded to switch 132 via fabric 110. With existing technologies, switch 132 may forward the join request back to fabric 110 while forwarding the request to fabric 120. Consequently, the multicast traffic distribution may not converge in fabric. On the other hand, the host and the source can be coupled to fabric 110 (or fabric 120). If switch 132 is configured as the RP for a multicast group, the join request from the host and the multicast data flow (or multicast flow) from the source can both be forwarded to switch 132. Accordingly, switch 132 can add the requesting switch to the OList of the multicast group. Hence, switch 132 may forward the multicast flow to the requesting switch. However, the multicast flow can also be directly forwarded to the requesting switch from the source switch via a corresponding tunnel in fabric 110. As a result, the requesting switch may receive multiple multicast flows.

Because switch 132 can be coupled to fabrics 110 and 120, switch 110 needs to enforce split horizon rules for inter-fabric traffic. For example, a packet received from an inter-fabric tunnel coupling 110 may not be forwarded to another inter-fabric tunnel to fabric 110. Hence, switch 132 needs to distinguish between fabrics 110 and 120 at site 102. Moreover, a gateway switch, such as switch 112, may use iBGP and eBGP to determine routes for inter- and intra-fabric tunnels, respectively. However, fabric 110 may include an RS, which can be an underlay device that does not operate as a tunnel endpoint in fabric 110 and can relay route advertisements using eBGP. In other words, the RS may operate as a route-relay entity among eBGP peers. As a result, the route advertisements relayed by the RS can be based on eBGP. Consequently, gateway switch 112 may not be able to distinguish between inter- and intra-fabric tunnels using eBGP and iBGP, respectively.

To address these problems, a respective switch, such as switch 112, operating as a tunnel endpoint in network 100 can be configured with a set of hierarchical identifiers. Each of these identifiers can correspond to a hierarchy of topology and configuration for the switch. For example, fabrics 110 and 120 can be associated with fabric identifiers 142 and 144, respectively. Furthermore, site 102 can be associated with site identifier 140. These identifiers can be configured by an administrator or generated based on local information, such as MAC and IP addresses. Since switches 112, 114, and 116 are tunnel endpoints in fabric 110 at site 102, the hierarchical identifiers associated with these switches can include fabric identifier 142 and site identifier 140. Similarly, since switches 122, 124, and 126 are tunnel endpoints in fabric 120 at site 102, the hierarchical identifiers associated with these switches can include fabric identifier 144 and site identifier 140. The depth value of the hierarchical identifiers can then be two. Here, the depth value can indicate the number of identifiers in the hierarchical identifiers.

In this way, the hierarchical identifiers can group the switches of network 100 at different hierarchies. In network 100, site 102 includes two fabrics 110 and 120. Hence, switches 112 and 122 of fabrics 110 and 120, respectively, can have the same site identifier 140 while having different fabric identifiers 142 and 144, respectively. Switch 112 can send an overlay route packet 152 to advertise its associated hierarchical identifiers 140 and 142. Packet 152 can include a set of dedicated fields to incorporate depth value 162, which can include a value of two, and hierarchical identifiers 142 and 140. A respective field allocated for an identifier can have a predefined number of bits, which may or may not be the same. Furthermore, the sequence of these identifiers can also be predefined among the dedicated fields. For example, if the depth value is one, packet 152 is expected to include a fabric identifier of a predetermined number of bits. On the other hand, if the depth value is one, packet 152 is expected to include a site identifier of a predetermined number of bits followed by the fabric identifier.

In packet 152, the first identifier can be fabric identifier 142 followed by site identifier 140. In the same way, switch 122 can send an overlay route packet 154 to advertise its associated hierarchical identifiers 140 and 144. Packet 154 can include a depth value of 164 of two, and fabric identifier 142 followed by site identifier 140. Switches 114, 116, 124, and 126 can also send respective overlay route packets to notify switch 132 regarding the local hierarchical identifiers. When switch 132 receives packet 152, switch 132 can determine from depth value 162 that packet 152 includes two identifiers. Switch 132 can then parse the next predetermined number of bits associated with a fabric identifier to obtain identifier 142 and determine that as a fabric identifier based on the predefined sequence. Subsequently, switch 132 can parse the next predetermined number of bits associated with a site identifier to obtain identifier 140 and determine that as a site identifier based on the predefined sequence. In the same way, when switch 132 receives packet 154, switch 132 can determine from depth value 164 that packet 154 includes two identifiers.

Switch 132 can then determine fabric identifiers 144 and site identifier 140 from packet 154 based on the depth value, the predefined sequence, and the respective predetermined number of bits of fabric and site identifiers. Switch 132 can maintain a data structure with one or more entries. A respective entry of the data structure can map an address (e.g., an IP or MAC address) of a switch to the set of hierarchical identifiers associated with the switch. Switch 132 can then map identifiers 142 and 140 to an address of switch 112 (e.g., based on the IP address of switch 112), and identifiers 144 and 140 to an address of switch 122. Switch 112 may also include other identifiers associated with switch 112 in the set of hierarchical identifiers in packet 152. Examples of the other identifiers can include, but are not limited to, a VNI, a VLAN, a role identifier, and a chassis number. Similarly, packet 154 can include other identifiers associated with switch 122. If the same VNI is advertised from both fabrics 110 and 120, switch 132 can determine that the VNI is to be extended across fabrics 110 and 120.

Since fabrics 110 and 120 deploy EVPN 106 and 108, respectively, packets 152 and 154 can be EVPN route advertisements and the dedicated fields can be an extended community defined for the EVPN route advertisements. The minimum depth value of the community can be one wherein the community can include a fabric identifier. The community can carry the number of hierarchical identifiers indicated by the depth value. The community can be transitive and optional. Furthermore, a respective overlay route packet can include route advertisements (e.g., EVPN NLRI and route target extended community). The switch receiving packets 152 and 154 can process the route advertisement. However, because the community is an optional field, if the receiving switch does not support the community, the switch may bypass the processing of the community.

Based on the hierarchical identifiers, switch 132 can implement a set of forwarding rules, such as split horizon rules, ISL rules, and broadcast domain rules, to determine whether a packet should be forwarded to another switch. The hierarchical fabric identifiers allow switch 132 to identify which switch belongs to which fabric. As a result, if a forwarding rule prevents switch 132 from forwarding a packet back to a fabric, switch 132 can use the hierarchical identifiers to apply the forwarding rule. In other words, the hierarchical identifiers allow switch 132 to identify a fabric and site associated with a respective switch and apply the forwarding rules accordingly.

Suppose that switch 132 is configured as an RP for a multicast group. Hosts 172 and 174 coupling fabrics 110 and 120, respectively, can request multicast data flow from the multicast group. During operation, switch 132 can receive a multicast packet from a source 170 of the multicast group via switch 112. Switch 132 can determine that the packet is received via a fabric associated with fabric identifier 142. Switch 132 can determine that host 172 is reachable via a fabric associated with the same fabric identifier 142. Switch 132 then refrain from forwarding the packet toward fabric 110 even when host 172 is coupled to fabric 110. On the other hand, switch 132 can determine that host 174 is reachable via a fabric associated with a different fabric identifier 144. Accordingly, switch 132 can forward the packet to fabric 120. In this way, the hierarchical identifiers can allow efficient forwarding in network 100.

FIG. 1B illustrates an example of multi-depth hierarchical identifiers in a multi-fabric overlay network, in accordance with an aspect of the present application. Depending on the topology, the hierarchical identifiers associated with different switches of network 100 can be different. There can be multiple mesh networks and associated broadcast domains (e.g., for different VLANs) among the switches of network 100. For example, there can be one or more mesh formed among the border switches of network 100. The mesh network formed by switches 132, 134, and 136 can be associated with a mesh identifier 148. If switch 132 sends an overlay route packet 156 to switch 134 of site 104, switch 132 can include a set of hierarchical identifiers that can also include mesh identifier 148.

Since there are multiple fabrics at site 102, external communication can be managed by switch 132. Switch 132 can then incorporate a default fabric identifier 146 (e.g., a value of 0) in packet 156 to consolidate route updates from fabrics 110 and 120, and advertise the consolidated route update across external links to remote sites, such as site 104. Switch 132 can also include site identifier 140 in packet 156. Therefore, depth value 166 of packet 156 can be three. However, since the switches of fabric 110 are not associated with mesh identifier 148, overlay route packet 152 from switch 112 can include fabric identifier 142 and site identifier 140 with a depth value 162 of two. Therefore, hierarchical identifiers of different switches of network 100 can have different depths.

When switch 134 receives packet 156, switch 134 can determine that switch 132 is associated with default fabric identifier 146. Hence, switch 134 can associate advertised routes in packet 156 with site identifier 140, which can be independent of fabric 110 and 120. Accordingly, switch 134 can forward control and data packets to switch 132 via network 150 without considering individual fabrics 110 and 120. In this way, advertising the hierarchical identifiers via overlay route packets 152 and 156 can ensure efficient traffic forwarding in network 100.

Hierarchical identifiers can be used to distinguish different broadcast domains (e.g., associated with different tenants). FIG. 1C illustrates an example of broadcast-domain-level hierarchical identifiers in a multi-fabric overlay network, in accordance with an aspect of the present application. Distinguishing based on fabric identifiers can be required at a sub-BGP-peer level. For example, broadcast domains 182 and 184, which can be represented by corresponding VNIs, can be extended across sites 102 and 104. However, broadcast domain 182 can be extended across fabrics 110 and 120 while broadcast domain 184 can be extended across fabric 120. Under such circumstances, fabric identifiers 142 and 144 can be associated with broadcast domain 182. A different fabric identifier 180 can be allocated to fabric 120 in association with broadcast domain 184. Hence, fabric 120 can be associated with fabric identifiers 144 and 180 for broadcast domains 182 and 184, respectively.

In addition to packet 154, switch 122 can also send an overlay route packet 158 to advertise its associated hierarchical identifiers 140 and 180. Packet 158 can include a depth value 168 of two, and fabric identifier 180 followed by site identifier 140. Switches 114, 116, 124, and 126 can also send respective overlay route packets to notify switch 132 regarding the local hierarchical identifiers comprising fabric identifiers 144 and 180. Accordingly, switch 132 can apply forwarding rules for fabric 120 for broadcast domain 182 based on fabric identifier 144. On the other hand, switch 132 can apply forwarding rules for fabric 120 for broadcast domain 184 based on fabric identifier 180.

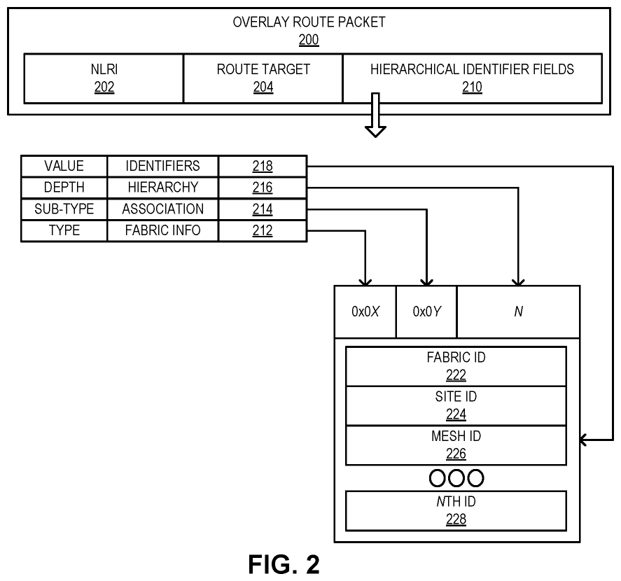

FIG. 2 illustrates an example of an overlay route packet for notifying hierarchical identifiers in an overlay network, in accordance with an aspect of the present application. An overlay route packet 200, such as an EVPN type 3 route update, can be used to advertise NLRI 202. NLRI 202 can correspond to an Inclusive Multicast Ethernet Tag (IMET) route. Packet 200 can also include a route target 204 extended community to indicate the VPN membership of the advertised prefixes. Route target 204 can be based on IP addresses or autonomous system (AS) numbers. Packet 200 can also include a set of hierarchical identifier fields 210. Fields 210 can represent a BGP Extended Communities Attribute, as defined in Internet Engineering Task Force (IETF) Request For Comments (RFC) 4360.

Fields 210 can include a set of sub-fields representing a set of hierarchical identifiers being advertised by a switch. The set of sub-fields can include a type 212, a sub-type 214, a depth value 216, and a value 218. Type 212 can indicate the generic type of field that can be defined in accordance with the standard (e.g., the BGP Extended Communities Attribute) associated with fields 210. To indicate the transitive nature of fields 210, a predetermined bit (e.g., the bit next to the most significant bit (MSB)) of a specialized value 0x0X of type 212 can be “0.” Sub-type 214 can be a specialized value 0x0 Y indicating that fields 210 can be associated with a set of hierarchical identifiers. Specialized value 0x0 Y of sub-type 214 can be selected from an undefined value indicated in RFC 4360.

Value 218 includes the set of hierarchical identifiers. Depth 216 can then indicate the depth of the hierarchy, which can be the number of identifiers included in value 218. For example, if the value of depth 216 is N, there can be N identifiers present in value 218. Value 218 can then include a fabric identifier 222, a site identifier 224, and a mesh identifier 226. In this way, value 218 can include up to an Nth identifier 228. Value 218 may also include other identifiers associated with the switch. Examples of the other identifiers can include, but are not limited to, a VNI, a VLAN, a role identifier, and a chassis number. If a set of hierarchical identifiers include a VNI or a VLAN, the set of hierarchical identifiers can be associated with that VNI or VLAN. This allows a fabric to have multiple fabric identifiers corresponding to different VNIs defined in the fabric.

The sequence of the identifiers in value 218 can be predefined. For example, if the value of Nis one, value 218 can include fabric identifier 222. On the other hand, if the value of Nis two, value 218 can include fabric identifier 222 and site identifier 224. Similarly, if the value of Nis three, value 218 can include fabric identifier 222, site identifier 224, and mesh identifier 226. The size or number of bits of each of these identifiers can also be predefined. The respective sizes can be the same (e.g., two octoates) or different. Based on the sequence of the identifiers, defined sizes of the identifiers, and the value of N indicated in depth 216, a receiving switch can determine a respective identifier from value 218.

Any switch that supports type 214 can recognize the specialized value and determine that fields 210 includes information indicating a set of hierarchical identifiers. The switch can then determine the depth value N from depth 216 and obtain N hierarchical identifiers specified in value 218. Fields 210 can be transitive because the community can be defined to be opaque for interoperability. As a result, if a switch does not support sub-type 214, the regular route advertisement can remain operational in the network. In particular, the switch may process NLRI 202 and route target 204. Furthermore, since fields 210 can be relayed via a tunnel, the switch can relay fields 210 to neighbor switches even if the switch does not support sub-type 214. Similarly, an RS can relay packet 200 to neighbor switches. Consequently, the efficient learning of the hierarchical identifiers can be supported in a heterogeneous overlay network with switches distributed in multiple fabrics and sites.

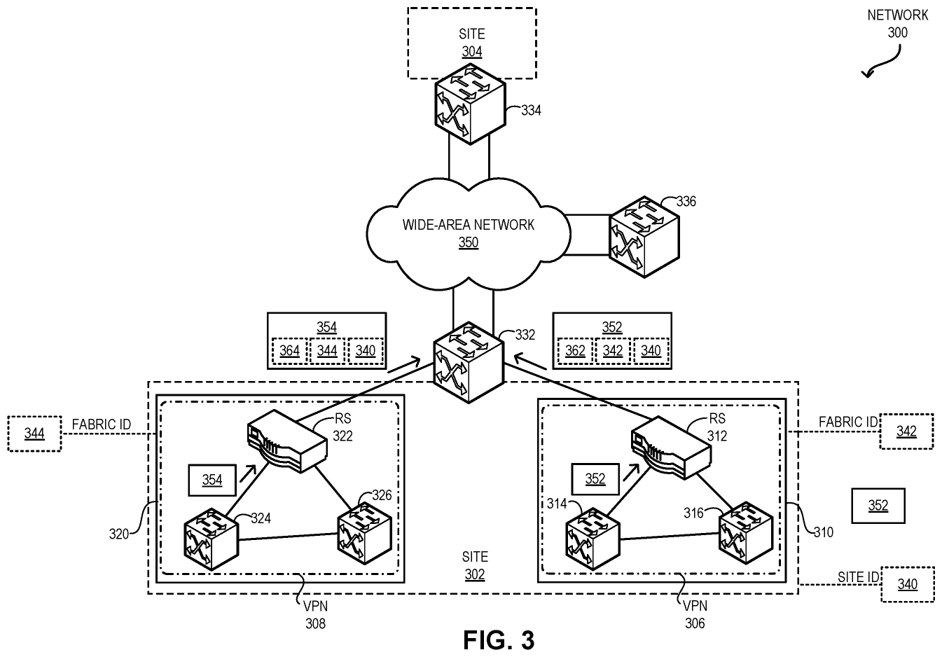

FIG. 3 illustrates an example of efficient traffic management in a multi-fabric overlay network based on hierarchical identifiers, in accordance with an aspect of the present application. An overlay network 300 can include a number of switches and devices, and may include heterogeneous network components, such as layer-2 and layer-3 hops, and tunnels. In some examples, network 300 can be an Ethernet, InfiniBand, or other networks, and may use a corresponding communication protocol, such as IP, FCOE, or other protocol. Network 300 can be distributed among multiple sites 302 and 304, which can be different sites of an enterprise network. Network 300 can include a plurality of distributed tunnel fabrics 310 and 320 at site 302. Hence, network 300 can be a multi-fabric network. Fabric 310 can include switches 314 and 316, and fabric 320 can include switches 324 and 328. A respective switch in a respective fabric can be associated with a MAC address and an IP address. A VPN 306, such as an EVPN, can be deployed over fabric 310. Similarly, a VPN 308 can be deployed over fabric 320.

In a respective fabric of network 300, switches can be coupled to each other via a tunnel. Examples of a tunnel can include, but are not limited to, VXLAN, GRE, NVGRE, Geneve, IPsec, MPLS, and GUE. The tunnels in a fabric can be formed over an underlying network (or an underlay network). The underlying network can be a physical network, and a respective link of the underlying network can be a physical link. A respective switch pair in the underlying network can be a BGP peer. Fabric 310 may include RS 312 via which switches 314 and 316 are reachable. Here, RS 312 can be an underlay device that does not operate as a tunnel endpoint of fabric 310 and can relay route advertisements. Similarly, fabric 320 may include RS 322 via which switches 324 and 326 are reachable. Even though intra-fabric route advertisements are distributed based on iBGP, RSs 312 and 322 can replay route advertisements based on eBGP. Consequently, switch 314 can be in one AS while switch 316 can be in another AS within fabric 310; and switch 324 can be in one AS while switch 326 can be in another AS within fabric 320.

A border switch 332 can be shared among fabrics 310 and 320. Hence, switch 332 can facilitate external communication from site 302 via network 350 (e.g., a WAN, which can be the Internet). Network 300 can also include switches 334 and 336 that can facilitate communication with switch 332 via network 350. For example, switches 332 and 334 can facilitate communication between sites 302 and 304 via network 350. In network 300, switch 332 can be coupled to switches 334 and 336 via respective inter-fabric tunnels through network 350. However, switch 332 is a shared border switch, switch 332 can also be coupled to fabrics 310 and 320 (e.g., via RSS 312 and 322, respectively) via the underlay network. Nonetheless, switch 332 can maintain tunnels with switches 314 and 316 via RS 312, and with switches 324 and 326 via RS 322.

A respective switch, such as switch 314, operating as a tunnel endpoint in network 300 can be configured with a set of hierarchical identifiers. Fabrics 310 and 320 can be associated with fabric identifiers 342 and 344, respectively. Furthermore, site 302 can be associated with site identifier 340. These identifiers can be configured by an administrator or generated based on local information, such as MAC and IP addresses. Since switches 314 and 316 are tunnel endpoints in fabric 310 at site 302, the hierarchical identifiers associated with these switches can include fabric identifier 342 and site identifier 340 even though these switches may be in different AS. Similarly, the hierarchical identifiers associated with switches 324 and 326 can include fabric identifier 344 and site identifier 340 even though these switches may be in different AS.

Switch 314 can send an overlay route packet 352 to advertise its associated hierarchical identifiers 340 and 342. Packet 352 can include a set of dedicated fields to incorporate depth value 362, which can include a value of two, fabric identifier 342, and site identifier 340. RS 312 can relay packet 352 to switch 332 without processing packet 352. Similarly, switch 322 can send an overlay route packet 354 to advertise its associated hierarchical identifiers 340 and 344. Packet 354 can include a depth value 364 of two, and fabric identifier 342 followed by site identifier 340. RS 322 can relay packet 354 to switch 332 without processing packet 354. Switches 316 and 326 can also send respective overlay route packets to notify switch 332 regarding the local hierarchical identifiers.

Upon receiving packet 352, switch 332 can discover the hierarchical identifiers associated with switch 314 even though packet 352 can be received via RS 312. In the same way, switch 332 can discover the hierarchical identifiers associated with switch 324 from packet 354 even though packet 352 can be received via RS 322. Switch 332 can maintain a data structure with one or more entries. A respective entry of the data structure can map an address (e.g., an IP or MAC address) of a switch to the set of hierarchical identifiers associated with the switch. Switch 332 can then map identifiers 342 and 340 to an address of switch 312 (e.g., based on the IP address of switch 312), and identifiers 344 and 340 to an address of switch 322. Based on the entries in the data structure, switch 332 can apply the forwarding rules in network 300.

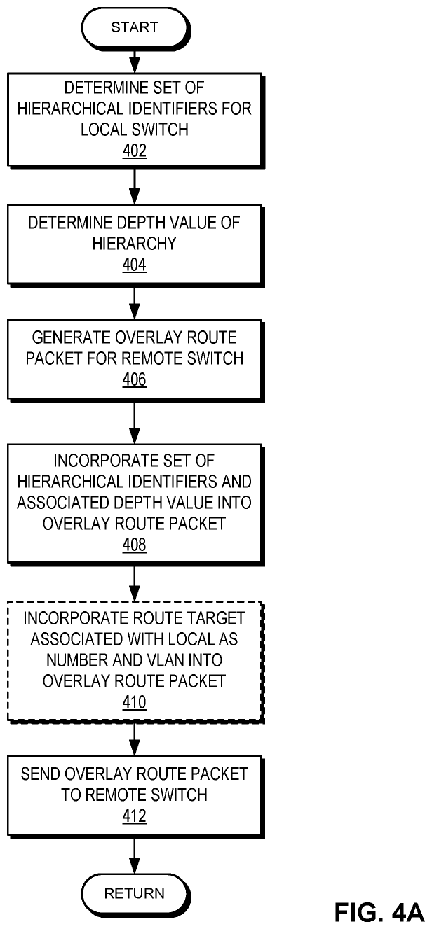

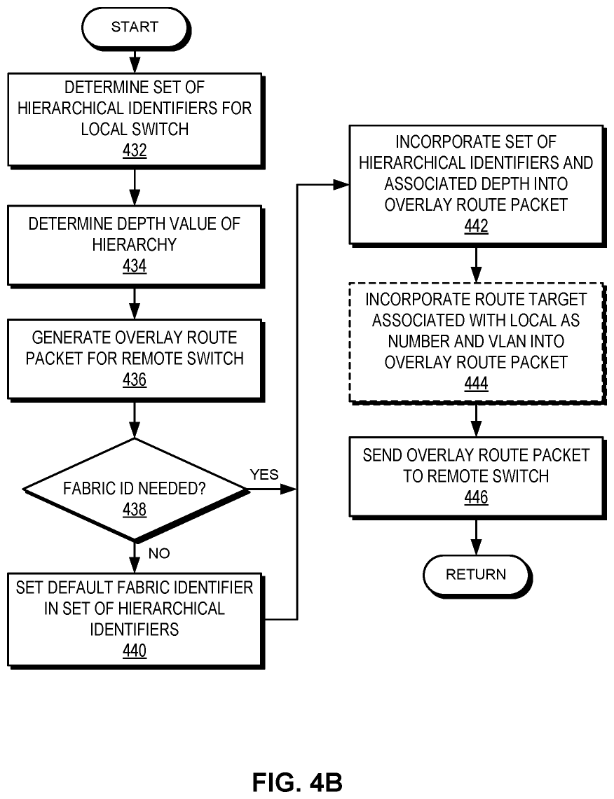

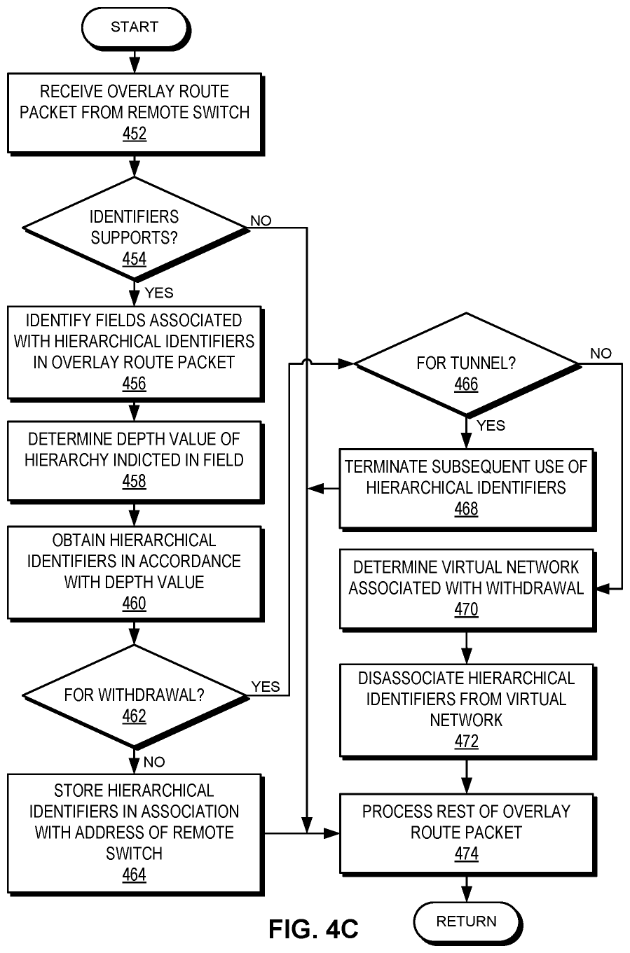

FIG. 4A presents a flowchart illustrating an example of a process of a switch distributing hierarchical identifiers in an overlay network, in accordance with an aspect of the present application. During operation, the switch can determine a set of hierarchical identifiers for the local switch (operation 402). These identifiers can be configured for the switch by an administrator. The switch can also generate the hierarchical identifiers from the local addresses. For example, the switch can apply a hash function to a combination of the addresses (e.g., IP or MAC addresses) of the local fabric to generate the fabric identifier. The switch can determine the depth value of the hierarchy (operation 404). The depth value can indicate the number of identifiers in the set of hierarchical identifiers.

The switch can then generate an overlay route packet for a remote switch (operation 406). The remote switch can be a switch of the local or remote site. The switch can incorporate the set of hierarchical identifiers and the associated depth value into the overlay route packet (operation 408). The switch may, optionally, also incorporate a route target associated with the local AS number and VLAN into the overlay route packet (denoted with dashed lines) (operation 410). The hierarchical identifiers and the route target can be incorporated into respective extended communities of the overlay route packet. The switch can then send the overlay route packet to the remote switch (operation 412).

FIG. 4B presents a flowchart illustrating an example of a process of a border switch distributing hierarchical identifiers in an overlay network, in accordance with an aspect of the present application. During operation, the switch can determine a set of hierarchical identifiers for the local switch (operation 432). If the switch is part of one or more mesh networks, the hierarchical identifiers may include a mesh identifier as well. The switch can also determine the depth value of the hierarchy (operation 434) and generate an overlay route packet for a remote switch (operation 436). Since the switch is a border switch of a site, the local fabric identifiers may not be relevant to outside switches. The switch can then determine whether fabric identifiers associated with local fabrics are needed (operation 438).

If fabric identifiers are not needed, the switch can set a default fabric identifier (e.g., a value of zero) in the set of hierarchical identifiers (operation 440). If fabric identifiers are needed (operation 438) or upon setting the default fabric identifier (operation 440), the switch can incorporate the set of hierarchical identifiers and the associated depth value into the overlay route packet (operation 442). The switch may, optionally, also incorporate a route target associated with the local AS number and VLAN into the overlay route packet (denoted with dashed lines) (operation 444). The switch can then send the overlay route packet to the remote switch (operation 446).

FIG. 4C presents a flowchart illustrating an example of a process of a switch processing hierarchical identifiers in an overlay network, in accordance with an aspect of the present application. During operation, the switch can receive an overlay route packet from a remote switch (operation 452) and determine whether the switch can support hierarchical identifiers (operation 454). To do so, the switch can determine whether the fields associated with the hierarchical identifiers (e.g., the extended community) are recognized by the local switch. If the switch supports hierarchical identifiers, the switch can identify fields associated with the hierarchical identifiers in the overlay route packet (operation 456) and determine the depth of the hierarchy indicated in the corresponding field (operation 458).

The switch can then obtain the hierarchical identifiers in accordance with the depth value (operation 460). The switch can also use the predetermined sequence of the hierarchical identifiers and respective identifier sizes to determine the respective locations of the hierarchical identifiers in the overlay route packet (e.g., in the extended community). The switch can then determine whether the overlay route packet is for the withdrawal of a route (operation 462). If the overlay route packet is not for withdrawal, the switch can store the hierarchical identifiers in association with an address of the remote switch (operation 464). If the overlay route packet is for withdrawal, the switch can determine whether the withdrawal is for a tunnel (operation 466).

If the withdrawal is for a tunnel, the switch can terminate the subsequent use of the hierarchical identifiers (operation 468). On the other hand, if the withdrawal is not for a tunnel, the withdrawal can be for a virtual network (e.g., an EVPN instance or EVI). The switch can then determine the virtual network associated with the withdrawal (operation 470) and disassociate the hierarchical identifiers from the virtual network (operation 472). Alternatively, for a withdrawal for a particular EVI, the fabric identifiers may not be included in the overlay route packet. If the switch does not support hierarchical identifiers (operation 454) or upon storing, terminating, or disassociating the hierarchical identifiers (operation 464, 468, or 472, respectively), the switch can continue to process the rest of the overlay route packet (e.g., the route advertisements and route target) (operation 474).

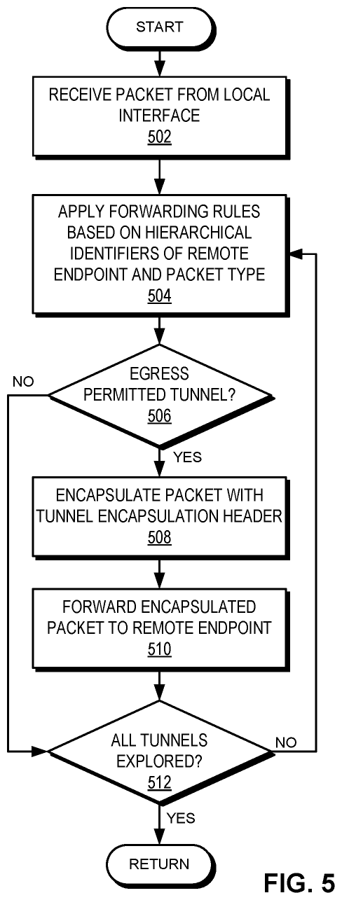

FIG. 5 presents a flowchart illustrating an example of a process of a switch forwarding traffic in an overlay network based on hierarchical identifiers, in accordance with an aspect of the present application. During operation, the switch can receive a packet from a local interface (e.g., a port or a tunnel) (operation 502). The switch can then apply the forwarding rules based on the hierarchical identifiers associated with a remote tunnel endpoint and the packet type (e.g., multicast or unicast) (operation 504). Here, a tunnel can exist between the switch and the remote tunnel endpoint. Accordingly, the switch can determine whether egress is permitted via the tunnel (operation 506).

If egress is permitted, the switch can encapsulate the packet with a tunnel encapsulation header (operation 508) and forward the encapsulated packet to the remote endpoint (operation 510). The switch can then determine whether all tunnels of the switch are explored (operation 512). If all tunnels are not explored, the switch can continue to apply the forwarding rules based on the hierarchical identifiers associated with another remote tunnel endpoint and the packet type (e.g., multicast or unicast) (operation 504). In this way, the switch can efficiently apply the forwarding rules of a network based on the hierarchical identifiers.

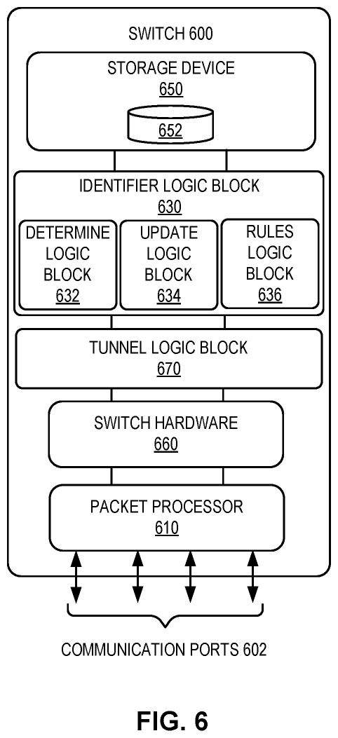

FIG. 6 illustrates an example of a switch supporting efficient traffic management based on hierarchical identifiers, in accordance with an aspect of the present application. In this example, a switch 600 can include a number of communication ports 602, a packet processor 610, and a storage device 650. Switch 600 can also include switch hardware 660 (e.g., processing hardware of switch 600, such as its application-specific integrated circuit (ASIC) chips), which includes information based on which switch 600 processes packets (e.g., determines output ports for packets). Packet processor 610 can extract and processes header information from the received packets. Packet processor 610 can identify a switch identifier (e.g., a MAC address and/or an IP address) associated with switch 600 in the header of a packet.

Communication ports 602 can include inter-switch communication channels for communication with other switches and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Switch 600 can maintain a database 652 (e.g., in storage device 650). Database 652 can be a relational database and may run on one or more Database Management System (DBMS) instances. Database 652 can store information associated with the routing, configuration, and interfaces of switch 600. Database 652 may store the routing data structure (e.g., an RIB) for switch 600. Database 652 can also store hierarchical identifiers of local and remote switches. Switch 600 can include a tunnel logic block 670 that can establish a tunnel with a remote switch in an overlay network, thereby allowing switch 600 to operate as a tunnel endpoint. Switch 600 can include an identifier logic block 630 that can allow switch 600 to determine, distribute, and apply hierarchical identifiers.

Identifier logic block 630 can include a determine logic block 632, an update logic block 634, and a rules logic block 636. Determine logic block 632 can determine a set of hierarchical identifiers associated with switch 600. Determine logic block 632 can determine the hierarchical identifiers based on locally configured identifiers or network addresses associated with switch 600. Update logic block 634 can update a local data structure based on the hierarchical identifiers of a remote endpoint learned from an overlay route packet. Update logic block 634 can also notify a respective remote tunnel endpoint regarding the hierarchical identifiers associated with switch 600. Rules logic block 636 can apply forwarding rules based on the hierarchical identifiers.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a system for efficient traffic management. During operation, the system can receive a first route update via a first tunnel coupling a first switch in a first overlay tunnel fabric of a site of a network. The first route update can include a first set of hierarchical identifiers associated with the first switch. Here, a respective identifier of the first set of hierarchical identifiers can correspond to a distinct networking hierarchy with respect to the first switch. The system can also receive a second route update via a second tunnel coupling a second switch in a second overlay tunnel fabric of the site. The second route update can include a second set of hierarchical identifiers associated with the second switch. The encapsulation of a packet sent via an overlay tunnel fabric is initiated and terminated within the overlay tunnel fabric. Upon receiving a packet via a tunnel, the system can determine whether to forward the packet to the first switch and the second switch based on the first and second sets of hierarchical identifiers, respectively.

In a variation on this aspect, the system can determine whether to forward the packet by determining the fabric membership of the first and second switches based on the first and second sets of hierarchical identifiers, respectively.

In a variation on this aspect, the first set of hierarchical identifiers can include one or more of: a fabric identifier identifying the first overlay tunnel fabric, a site identifier identifying the site, a mesh identifier identifying a mesh network comprising the first switch, a virtual network identifier (VNI) associated with the first switch, a virtual local area network (VLAN) associated with the first switch, a role identifier for facilitating role-based traffic segmentation, and a chassis number of the first switch.

In a variation on this aspect, the first overlay tunnel fabric includes an Ethernet virtual private network (EVPN). The first route update can be an EVPN route update that includes the first set of hierarchical identifiers in a transitive extended community.

In a variation on this aspect, the first and second route updates can be relayed via respective route servers. Here, a respective route server can operate as a route reflector capable of relaying route updates based on an external Border Gateway Protocol (eBGP).

In a variation on this aspect, the system can determine, on the first and second sets of hierarchical identifiers, that the first and second overlay tunnel fabrics are associated with the same site identifier. The system can then consolidate upstream route updates from the first and second overlay tunnel fabrics into a single route update based on the site identifier.

In a variation on this aspect, the system can operate on a Rendezvous Point (RP) for a multicast group. The packet can then be a multicast packet of the multicast group from the first fabric. The system can then associate the first and second switches with the first and second overlay tunnel fabrics, respectively, based on corresponding sets of hierarchical identifiers. Subsequently, the system can forward the packet to the second switch and refrain from forwarding the packet to the first switch.

In a variation on this aspect, the system can operate on a switch configured with a set of VNIs. The system can then determine which VNI of the set of VNIs is to be extended for which fabric based on the first and second sets of hierarchical identifiers.

In a variation on this aspect, the system can store, in a local data structure, the first and second sets of hierarchical identifiers in association with respective network addresses of the first and second switches.

The data structures and code described in this detailed description are typically stored on a computer-readable storage medium, which may be any device or medium that can store code and/or data for use by a computer system. The computer-readable storage medium can include, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and codes and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block, a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
receiving, by a border switch of a site, a first route update via a first tunnel coupling a first switch in a first overlay tunnel fabric of the site, wherein the first route update includes a first set of hierarchical identifiers associated with the first switch, and wherein a respective identifier of the first set of hierarchical identifiers corresponds to a distinct networking hierarchy with respect to the first switch;
receiving, by the border switch, a second route update via a second tunnel coupling a second switch in a second overlay tunnel fabric of the site, wherein the second route update includes a second set of hierarchical identifiers associated with the second switch, wherein encapsulation of a packet sent via an overlay tunnel fabric is initiated and terminated within the overlay tunnel fabric;
receiving, by the border switch, a packet via a tunnel; and
determining, by the border switch, whether to forward the packet to the first switch and the second switch based on the first and second sets of hierarchical identifiers, respectively.

2. The method of claim 1, wherein determining whether to forward the packet further comprises determining fabric membership of the first and second switches based on the first and second sets of hierarchical identifiers, respectively.

3. The method of claim 1, wherein the first set of hierarchical identifiers include one or more of: a fabric identifier identifying the first overlay tunnel fabric, a site identifier identifying the site, a mesh identifier identifying a mesh network comprising the first switch, a virtual network identifier (VNI) associated with the first switch, a virtual local area network (VLAN) associated with the first switch, a role identifier for facilitating role-based traffic segmentation, and a chassis number of the first switch.

4. The method of claim 1, wherein the first overlay tunnel fabric includes an Ethernet virtual private network (EVPN), and wherein the first route update is an EVPN route update that includes the first set of hierarchical identifiers in a transitive extended community.

5. The method of claim 1, wherein the first and second route updates are relayed via respective route servers, and wherein a respective route server operates as a route reflector capable of relaying route updates based on an external Border Gateway Protocol (eBGP).

6. The method of claim 1, further comprising:
determining, by the border switch based on the first and second sets of hierarchical identifiers, that the first and second overlay tunnel fabrics are associated with a same site identifier; and
consolidating upstream route updates from the first and second overlay tunnel fabrics into a single route update based on the site identifier.

7. The method of claim 1, wherein the border switch is configured as a Rendezvous Point (RP) for a multicast group, and wherein the packet is a multicast packet of the multicast group from the first fabric; and
wherein the method further comprises:
associating the first and second switches with the first and second overlay tunnel fabrics, respectively, based on corresponding sets of hierarchical identifiers;
forwarding the packet to the second switch; and
refraining from forwarding the packet to the first switch.

8. The method of claim 1, wherein a set of VNIs are configured at the border switch; and
wherein the method further comprises determining which VNI of the set of VNIs is to be extended for which fabric based on the first and second sets of hierarchical identifiers.

9. The method of claim 1, further comprising storing, in a data structure of the border switch, the first and second sets of hierarchical identifiers in association with respective network addresses of first and second switches.

10. A non-transitory computer-readable storage medium storing instructions that when executed by a processor of a switch in a site of a network cause the processor to perform a method, the method comprising:
receiving a first route update via a first tunnel coupling a first switch in a first overlay tunnel fabric of the site, wherein the first route update includes a first set of hierarchical identifiers associated with the first switch, and wherein a respective identifier of the first set of hierarchical identifiers corresponds to a distinct networking hierarchy with respect to the first switch;
receiving a second route update via a second tunnel coupling a second switch in a second overlay tunnel fabric of the site, wherein the second route update includes a second set of hierarchical identifiers associated with the second switch, wherein encapsulation of a packet sent via an overlay tunnel fabric is initiated and terminated within the overlay tunnel fabric;
receiving a packet via a tunnel; and
determining whether to forward the packet to the first switch and the second switch based on the first and second sets of hierarchical identifiers, respectively.

11. The non-transitory computer-readable storage medium of claim 10, wherein determining whether to forward the packet further comprises determining fabric membership of the first and second switches based on the first and second sets of hierarchical identifiers, respectively.

12. The non-transitory computer-readable storage medium of claim 10, wherein the first set of hierarchical identifiers include one or more of: a fabric identifier identifying the first overlay tunnel fabric, a site identifier identifying the site, a mesh identifier identifying a mesh network comprising the first switch, a virtual network identifier (VNI) associated with the first switch, a virtual local area network (VLAN) associated with the first switch, a role identifier for facilitating role-based traffic segmentation, and a chassis number of the first switch.

13. The non-transitory computer-readable storage medium of claim 10, wherein the first overlay tunnel fabric includes an Ethernet virtual private network (EVPN), and wherein the first route update is an EVPN route update that includes the first set of hierarchical identifiers in a transitive extended community.

14. The non-transitory computer-readable storage medium of claim 10, wherein the first and second route updates are relayed via respective route servers, and wherein a respective route server operates as a route reflector capable of relaying route updates based on an external Border Gateway Protocol (eBGP).

15. The non-transitory computer-readable storage medium of claim 10, wherein the method further comprises:
determining, based on the first and second sets of hierarchical identifiers, that the first and second overlay tunnel fabrics are associated with a same site identifier; and
consolidating upstream route updates from the first and second overlay tunnel fabrics into a single route update based on the site identifier.

16. The non-transitory computer-readable storage medium of claim 10, wherein the switch is configured as a Rendezvous Point (RP) for a multicast group, and wherein the packet is a multicast packet of the multicast group from the first fabric; and
wherein the method further comprises:
associating the first and second switches with the first and second overlay tunnel fabrics, respectively, based on corresponding sets of hierarchical identifiers;
forwarding the packet to the second switch; and
refraining from forwarding the packet to the first switch.

17. The non-transitory computer-readable storage medium of claim 10, wherein a set of VNIs are configured at the switch; and
wherein the method further comprises determining which VNI of the set of VNIs is to be extended for which fabric based on the first and second sets of hierarchical identifiers.

18. The non-transitory computer-readable storage medium of claim 10, wherein the method further comprises storing, in a data structure of the switch, the first and second sets of hierarchical identifiers in association with respective network addresses of first and second switches.

19. A computer system, comprising:
a processor;
a memory device;
a first communication port to receive a first route update via a first tunnel coupling a first switch in a first overlay tunnel fabric of a site of a network, wherein the first route update includes a first set of hierarchical identifiers associated with the first switch, and wherein a respective identifier of the first set of hierarchical identifiers corresponds to a distinct networking hierarchy with respect to the first switch;
a second communication port to receive a second route update via a second tunnel coupling a second switch in a second overlay tunnel fabric of the site, wherein the second route update includes a second set of hierarchical identifiers associated with the second switch, wherein encapsulation of a packet sent via an overlay tunnel fabric is initiated and terminated within the overlay tunnel fabric; and
control circuitry to:
determine that a packet is received via a tunnel; and
determine whether to forward the packet to the first switch and the second switch based on the first and second sets of hierarchical identifiers, respectively.

20. The computer system of claim 19, wherein the control circuitry determines whether to forward the packet by determining fabric membership of the first and second switches based on the first and second sets of hierarchical identifiers, respectively.
